(19) United States
(12) Patent Application Publication
(10) Pub. No.: US 2026/0289288 A1
(43) Pub. Date: Sep. 24, 2026

(54) EVENT-BASED NEURAL NETWORK PROCESSING SYSTEM

(71) Applicant: APPLIED BRAIN RESEARCH INC., Waterloo (CA)

(72) Inventors: Andreas STOCKEL, Waterloo (CA); Christopher ELIASMITH, Waterloo (CA)

(21) Appl. No.: 19/469,246

(22) PCT Filed: Mar. 26, 2024
(86) PCT No.: PCT/CA2024/050374

§ 371 Date: Sep. 25, 2025

Related U.S. Application Data
(60) Provisional application No. 63/454,716, filed on Mar. 26, 2023.

(51) Int. Cl. G06N 3/063; G06N 3/0464; G06N 3/049

(52) U.S. Cl. CPC G06N 3/063; G06N 3/0464; G06N 3/049

(57) ABSTRACT

A hardware-based processing system for event-based processing of neural networks comprises event buses and processing elements arranged in stages or layers. Each stage includes an event bus configured to receive events from one or more event producers and output them to event consumers, and one or more processing elements that implement the neural network connected to the event bus. The processing elements receive events from the event bus and process them in synaptic input and neural output stages to generate an output event that is output to the event bus of a later stage. Each processing element includes an address generator that determines target addresses for stored synaptic states and weights for events. Synchronisation is managed locally in each processing element by a phase controller based on the time indices of each event indicating a time-step or phase.

### CROSS-REFERENCE TO RELATED APPLICATIONS

This application claims priority to U.S. Provisional Application No. 63/454,716 filed Mar. 26, 2023 and entitled “HARDWARE DESIGN FOR EFFICIENT NEURAL PROCESSING” the entirety of which is incorporated herein by reference.

### TECHNICAL FIELD

The present disclosure relates to neural network hardware processing systems, and in particular to an event-based neural network processing system supporting both spiking and non-spiking convolutional neural networks.

### TECHNICAL BACKGROUND

Neural networks are traditionally partitioned into layers. When evaluating a network (also referred to as “inference”), the activity of all neurons in a source layer must be passed to all downstream neurons in the target layers. This is typically done by representing the activities of a layer as a vector \vec{x} (or more generally, as an n-dimensional array or “tensor”). This vector can be sequentially transmitted over a communication bus and/or stored contiguously in computing system memory. The fixed order of the state information in \vec{x} implicitly encodes the source neuron index.

This scheme is efficient if most neurons in the population are active, that is, the neurons have a non-zero state. Conversely, if it can be ensured that that most neurons in the network are not active, then transmitting the entire neural state vector \vec{x} becomes inefficient. This inefficiency is particularly severe if the network is used to process time-series data and the network is evaluated regularly at high frequencies—the communication and memory infrastructure are flooded with unnecessary “zeros”, thus wasting time and energy.

Event-based neural network evaluation is one way to handle this “time-series processing with sparse activities” scenario efficiently. Instead of relying on implicitly encoding neuron indices in the order in which neural activities are transmitted or stored, event-based neural network accelerators explicitly attach metadata to every word of state information being transmitted (or alternatively, ordered events can be packed into packets, with the packet headers containing metadata); if there is no information to transmit (e.g., because a neuron is not active), then no event is sent. These metadata are used as routing information that determines the target neurons that process the event. In a sense, event based neural network evaluation is a way to “compress” sparse activity vectors. In its purest form (i.e., without any additional payload, and using wall-time to encode the progression of time), the idea of using source metadata to signal activity is referred to as Address Event Representation (AER).

This scheme has several trade-offs compared to the standard method of transmitting dense vectors. First, it unavoidably introduces overhead for encoding the metadata attached to each event. Second, AER is hard to implement efficiently on traditional computer architectures that rely on memory hierarchies with caching: these systems are designed to handle contiguous writes to memory efficiently, but are ill-suited for the random access patterns resulting from unordered neural activity.

### BRIEF DESCRIPTION OF THE DRAWINGS

In drawings which illustrate by way of example only embodiments of the present invention,

FIG. 1 is a block diagram of example processing system architecture in a “2×3” configuration.

FIG. 2 is a block diagram of an example event bus within the processing system of FIG. 1.

FIG. 3 is a block diagram of an example format for events processed by the processing system.

FIG. 4 is a block diagram of example payload formats.

FIG. 5 is a timing diagram illustrating the progression of time in the processing system.

FIG. 6 is a block diagram of an example processing element within the processing system of FIG. 1.

FIG. 7 is a set of graphs comparing the impulse response for synaptic filters using different discretization methods.

FIG. 8 is a set of graphs illustrating synaptic time-constants that can be represented in the processing system.

FIG. 9 is a set of graphs illustrating output of a neural nonlinearity processor in a processing element.

FIG. 10 is a block diagram of an example format for neuron-to-synapse map data.

FIG. 11 is a block diagram of an example format for expressing a first neuron configuration.

FIG. 12 is a block diagram of an example format for expressing a second neuron configuration.

FIG. 13 is a block diagram of an internal stream interface and corresponding timing diagram.

FIG. 14 is a set of block diagrams of internal stream components.

FIG. 15 is a block diagram of an arithmetic logic unit of an address generator in the processing system.

### DETAILED DESCRIPTION

As noted above, while event-based neural network evaluation provides benefits when handling certain types of input data, prior art implementations of event-based neural network processing present their own inefficiencies compared to the standard method of transmitting dense vectors. First, prior art implementations unavoidably introduce overhead for encoding the metadata attached to each event. Second, AER is hard to implement efficiently on traditional computer architectures that rely on memory hierarchies with caching: these systems are designed to handle contiguous writes to memory efficiently, but are ill-suited for the random access patterns resulting from unordered neural activity.

Correspondingly, event-based neural network evaluation makes most sense if temporal sparsity can be enforced, and the networks are executed on special hardware without memory hierarchies. Inside the network, employing spiking neurons is the primary way to ensure temporal sparsity. These neurons can either be models of biological neurons, as for example the leaky-integrate-and-fire (LIF) neuron, or, more suitably for engineering contexts, ΔΣ-converters that track quantization error over time. Event-based processing is thus a natural fit with AES sensor devices such as dynamic vision sensor (DVS) cameras and artificial cochleas.

Accordingly, the present disclosure provides an event-based neural network hardware processor or accelerator (referred to herein as a “processing system” herein) for use in a host computing system. The event-based neural network hardware processing system supports local connectivity using local static random access memory (SRAM), is flexible, and supports two-dimensional (2D) convolution.

Local connectivity is provided by an architecture in which columns or groups of processing elements (holding neurons belonging to one or multiple layers) in a given stage or layer (i.e., corresponding to a particular event bus) support local recurrence and send their output to a subsequent stage containing another column or layer of processing elements. Typically, prior art event-based neural network accelerators place relatively few constraints on inter-neuron connectivity. That is, any neuron in the system could potentially send events to any other neuron in the system (see, e.g., the design of SpiNNaker, Intel® Loihi, or BrainScaleS). However, in practice—and outside computational neuroscience research (for which most of the aforementioned systems were designed)—neural network architectures for image or signal processing possess almost linear feed-forward connectivity graphs. That is, layers in a neural network can generally be sorted such that one layer sends information to a next layer. Similarly, recurrent connections (neurons indirectly or directly connecting to themselves) seldom span many layers. For example, long short-term memories (LSTMs) and Legendre memory units (LMUs) only use local feedback; that is, the current state is fed back to the layer that produced the state. The example embodiments discussed herein reflect this regularity in neural network design, which provides advantages such as the potential to reduce the number of events on the event bus, and the complexity of the routing system, thereby reducing resource requirements of the processing system. Additionally, source addresses are not required to be globally unique; in turn, a smaller source address space is required, further reducing complexity. Local connectivity thus helps reduce computational overhead even if neurons are continuously active.

The disclosed processing system is highly flexible, in that individual processing elements performing the neural network evaluation can in principle be arranged and connected in any manner. For example, in the processing system may be customized for specific purposes by instantiating the individual components of the system in a hardware description language (e.g., SystemVerilog™) and can be modified by the person of ordinary skill in the art without requiring deep understanding of low-level implementation details. Furthermore, the individual components of the processing system place relatively few constraints on possible connectivity. For instance, the event bus system supports an arbitrary number of input ports by automatically distributing events through a balanced binary tree of bus arbiters, and phase synchronisation and pipelining happens automatically through stream connections. This enables the processing system to be scaled to field programmable gate arrays (FPGAs) of various sizes, and to be adapted to support specific neural network topologies. For example, a specific class of networks may require many neurons in the first layers, but only a few neurons in subsequent layers. The network topology can be adapted accordingly.

Event-based neural network evaluation comes with the complication of resulting in seemingly random memory access patterns. This is not optimal for computer architectures with cache-based memory hierarchies—that is, modern CPUs and GPUs. Memory access latency can be reduced by bringing processing elements and the memory containing synaptic weights, neural state and activities physically closer together. Reduced memory access latency requires fewer hardware components aimed at shadowing latency (such as bulk transfers and caching). In turn, random memory access patterns caused by AER do not result in any performance penalty. This is closely related to the concept of “spatial computing”, where computation takes place over a larger area in many processing elements with small amounts of local memory, as opposed to few processing elements with large amounts of external memory. Thus, in the disclosed processing system, many processing elements communicate with local SRAM, or, using FPGA terminology, so-called Block RAM (BRAM). In the example implementation described below, each processing element (described in detail below) has access to eight SRAM blocks with word widths of 16, 18 and 32 bits. Thus, for example, in a processing system with 80 processing elements and a frequency of 200 MHz, this results in a theoretically available bandwidth of about 2.9 terabits per second, which is on the same order of magnitude as the external memory bandwidth of modern high-end graphics processing units. This volume of bandwidth enables the execution of neural networks at rates of more than 1000 time-steps per second.

To support 2D convolution, the disclosed processing system tags events with 2D coordinates that describe what source location the event corresponds to. This source location determines what target neurons need to be updated.

Two principal elements of the processing system are the processing element and the event bus. Processing elements perform the actual computation required for neural network evaluation, while the event bus is responsible for delivering events among the processing elements in a way that maintains temporal coherence of the events. Each processing element receives events, filters for events that the processing element is interested in, and outputs new events after some processing time. The event bus collects events from multiple producers, such as processing elements or an input data stream, and transmits them to consumers such as other processing elements or a stream output to send data to the host system. Generally, the processing system is structured to include a plurality of event buses and a plurality of processing elements effectively grouped in a set of stages, in which a stage includes an event bus configured to receive events from one or more upstream event producers and distribute them to connected processing elements that implement the neurons of the neural network. The processing elements in turn process the received events and produce output events. Several such stages may be connected, with the output of the processing elements of a previous stage being received by the event bus of a subsequent stage. The output of the final stage is then filtered, as required, and output to the host system.

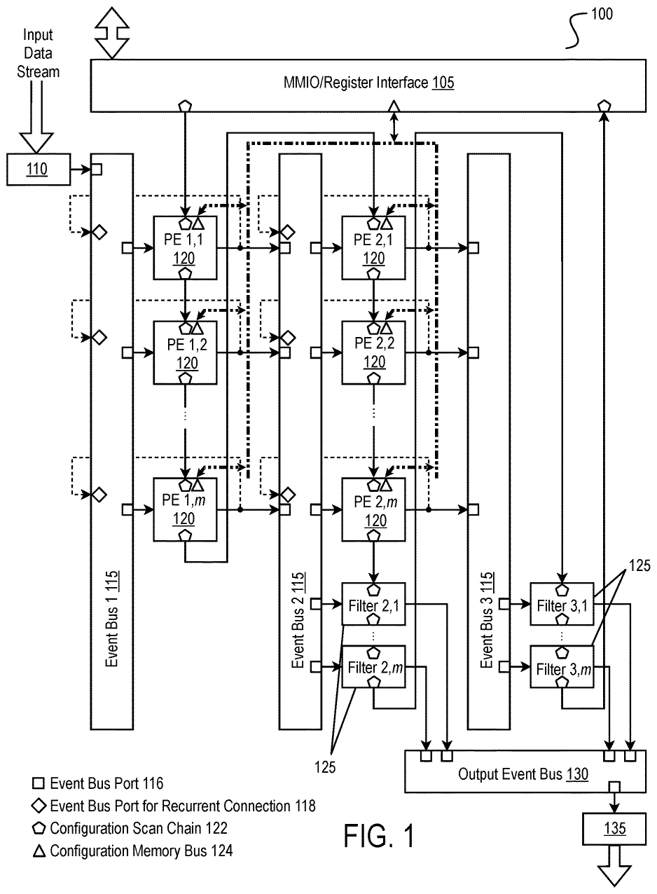

FIG. 1 is a schematic of an example architecture of a processing system 100 implementing a 2×3 configuration, that is to say, with two main event buses 115 and corresponding stages of processing elements 120, with three processing elements per event bus. As noted above, the processing system 100 may be configured with any appropriate number of processing elements 120 and event buses 115, depending on the neural network to be implemented by the processing system 100. Thus, there may be at least one processing element 120 per main event bus 115, and zero, one, or more intermediate stages between the first stage (in which the event bus 115 receives events from an input stream) and the final stage (in which events are directed to an output event bus 130). A stream receiver 110 receives an input data stream, while a register interface 105 receives configuration data. Data produced by the processing system 100, or output events, may be packetized by packetizer 135 prior to communication with the host system. External bus interfaces, not shown, are used to transmit data between receiver 110 or packetizer 135 and the host system.

Configuration data for the processing system 100 is written through the register interface 105. The configuration data employed in this example includes both configuration scan chain data (also referred to herein as a “configuration bitstream”) and configuration memory data. The configuration bitstream, indicated by the arrows connecting the configuration scan chain ports 122 in FIG. 1, is used to write data for individual registers distributed over the entire system. Registers contain bits of information that are available in every clock cycle, such as the event filter configuration, or the actual number of active neurons and synapses per processing element. These registers are arranged as part of a long shift-register or scan chain; in the example implementation, eight bits can be shifted into the scan chain at a time.

Configuration memory in the processing system 100 has a separate internal bus system, indicated by the arrows connecting the configuration memory bus ports 124 in FIG. 1. The SRAM blocks of all processing elements are mapped into a single global address space. These SRAM blocks contain data such as synaptic weights, synaptic decay parameters, and the source addresses of individual neurons in the processing element. In the example implementation discussed here, the host system may have full read-write access to the configuration memory, but the configuration scan chain may be write-only.

The event bus 115 receives events from one or more event producers, and broadcasts the events to all event consumers attached to the bus, as mentioned above, via ports 116 and 118. As can be seen in the example of FIG. 1, some event bus ports 118 are for recurrent connections, as indicated by their corresponding arrows: events received from a given bus 115 are processed by a processing element 120, and then provided again as an input event via a part 118. These ports 118 are optional, and need only be employed when a recurrent connection is required. Temporal coherence is ensured using a mechanism referred to here as “local phase synchronization”, in which all events belonging to a given input time-step are processed together before data belonging to the next time-step is passed on. “Time-step” or “phase”, used interchangeably, reference the network time or time index that indicates that a group of events belongs to the same logical evaluation group, e.g., the events belonging to the same discrete point in time in a time series. By contrast, a clock cycle refers to the clock driving the hardware.

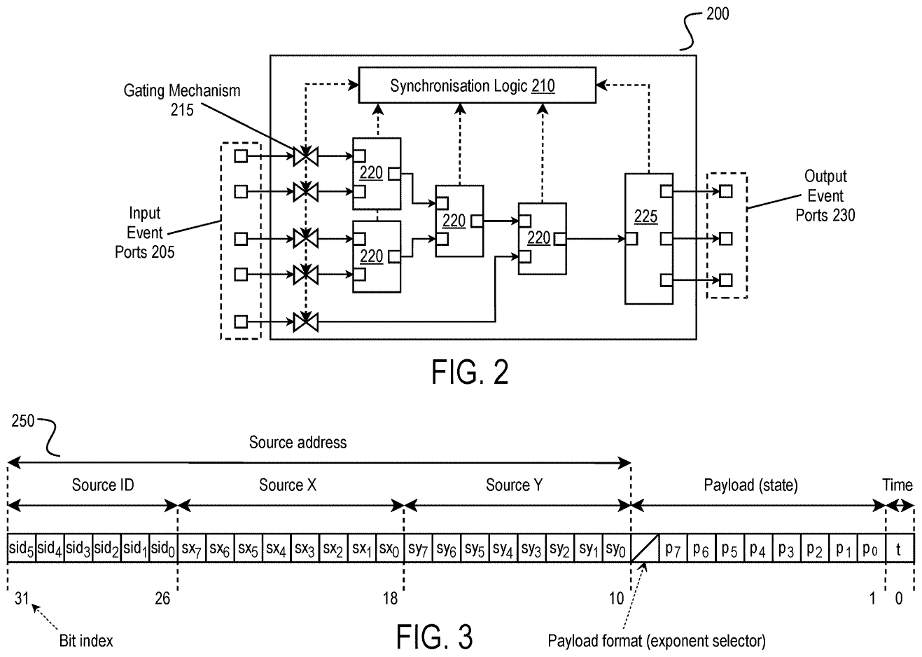

FIG. 2 illustrates the high-level architecture 200 of an example implementation of the event bus. The progress of input events through the event bus is controlled by the local phase synchronization logic module 210. Events received through one or more number of input event ports 205 pass through a gating mechanism 215, which only permits events to pass if their phase matches the current phase of the event bus. The events that pass through are then passed through a binary tree of arbiters 220, which ensures that each input port has the chance to forward its events. Finally, the currently selected input event is passed through a splitter 225 so that it may be broadcast to one or more connected output event ports 230. If all connected output event ports 230 have accepted the event, then a new event is allowed through the chain. Input event ports 205 with events not matching the current phase will stall, since the gating mechanism 215 will not permit the event to pass through. The event bus logic transitions to the next phase once all input event ports 205 stall, and all internal pipeline buffers have been flushed.

The number of input and output event ports 205, 230 may be selected arbitrarily according to the particular application; the example implementation of FIG. 2 may be referred to as a “five-to-three” configuration, with five input event ports 205 and three output event ports 230.

In the example implementation, to support two-dimensional convolution, enable both spiking and non-spiking communication, and to communicate the passage of time when processing time series, events are represented in a 32-bit format with a 22-bit source address, a 9-bit payload, and a 1-bit temporal index. The temporal index represents a time-step or phase of the event. Thus, when connected to a 32-bit external bus, a single event can be transferred to and from the hardware with every clock cycle. Similarly, this makes it possible to use narrow 32-bit buses within the processing system to transport events with a throughput of one event per cycle without taking up too many routing resources when implemented in an FPGA.

The event format scheme 250 is illustrated in FIG. 3. The 22-bit source address is split into three smaller parts: the source ID (6 bits), the source x-coordinate (8 bits), and the source y-coordinate (8 bits). The source ID can be used to indicate the layer or population of neurons that an event originated from. x- and y-coordinates are employed in this example instead of a linear neuron index to facilitate integration with AER sensors such as DVS cameras, since access to the source x- and y-coordinates is required to implement 2D convolution. With the coordinates represented by 8 bits each, images with more than 255 pixels in height or width may be distributed over multiple source IDs. In the case of a vectorial neuron population (i.e., one not representing an image) with more than 255 neurons, the population may be arranged in a rectangular configuration such that the population width w times height h closely matches the total number of neurons N (i.e., choose w≤255, h≤255 minimal such that w·h≥N). Since both the source and target layer inherently have a two-dimensional structure (albeit either width or height may be set to one), dense connection weights are technically arranged in a four-dimensional tensor instead of a two-dimensional matrix.

A special feature of the source address scheme is the particular source ID “0”, which indicates that an event is “invalid” or “no operation” and only sent for signaling purposes, for example to advance time if there are no events to process for that time-step.

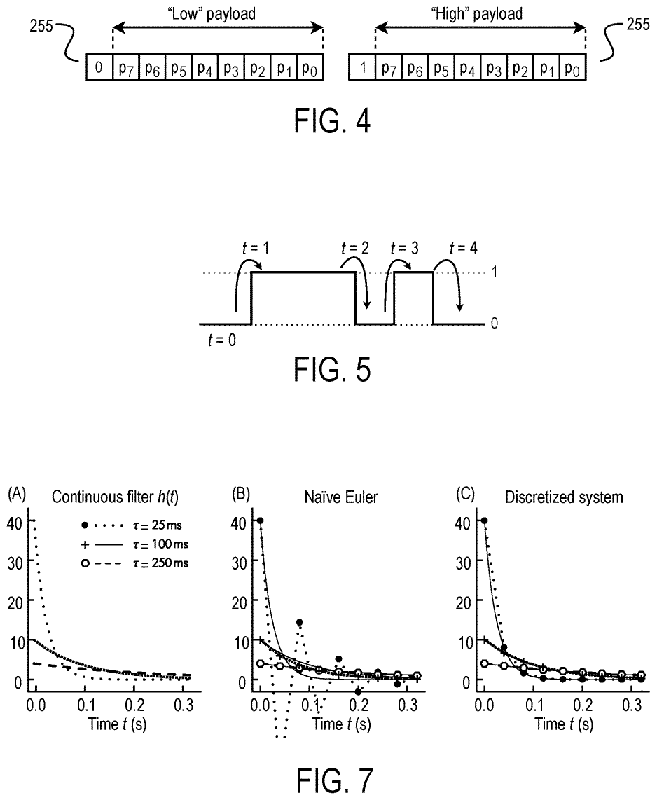

Each event is assigned a 9-bit payload to encode the actual neural state to be transmitted as either (signed) multi-bit spikes (encoded as integers) or fixed-point numbers as they might be used in a dense network. To increase the dynamic range of payloads that can be transmitted across the event bus without requiring wider events or complex packets, the 9-bit payload includes an exponent-selector bit as shown in the two example payload formats 255 illustrated in FIG. 4. This exponent selector bit is used to virtually shift the remaining 8 bits, which encode a signed two-complement's number between −128 and 127. For example, if the exponent selector bit is zero (the “low” value payload example in FIG. 4), then the 8-bit value is multiplied by 2⁻⁶; if the exponent selector bit is one (the “high” example in FIG. 4), then the value is multiplied by 2¹. Correspondingly, events with exponent selector zero represent numbers in the range −2 . . . 1.984375, and events with an exponent selector of one are in the range −256 . . . 254.

To transmit larger values while maintaining resolution, the payload is distributed over multiple events. This is possible because the synaptic input stage is linear. It does not matter in which order a payload split into multiple summands is processed; in fact, the event bus can reorder the payloads originating from different producers without changing the outcome of the computation. The processing elements 120 are configured to automatically pack and unpack their results into an optimal sequence of events. Table 1 below provides examples of how payloads may be transmitted over multiple events:

TABLE 1
Splitting payloads into multiple events.

| | Distribution over | | Hexadecimal |
|---|---|---|---|
| Value | Multiple Events | Computation | Representation |
| 1 | 1 | 64 · 2⁻⁶ | 0x040 |
| −1 | −1 | −64 · 2⁻⁶ | 0x0C0 |
| 2 | 2 | 1 · 2¹ | 0x101 |
| −2 | −2 | −128 · 2⁻⁶ | 0x080 |
| 3.75 | 2 + 1.75 | 1 · 2¹ + 112 · 2⁻⁶ | 0x101 0x070 |
| 560.25 | 254 + 254 + 52 + 0.25 | 127 · 2¹ + 127 · 2¹ + | 0x17F 0x17F 0x11A 0x010 |
| | | 26 · 2¹ + 16 · 2⁻⁶ | |
| −560.25 | (−256) + (−256) + | (−128) · 2¹ + (−128) · 2¹ + | 0x180 0x180 0x1E8 0x0F0 |
| | (−48) + (−0.25) | (−24) · 2¹ + (−16) · 2⁻⁶ | |

In dense neural network applications where the fractional payload resolution of 1/64 (2⁻⁶) is insufficient, higher resolutions can be achieved by using larger neural activities. This may require scaling all weights and biases in the network by some factor γ and scaling the output of the network back by γ⁻¹.

Returning to FIG. 3, the single-bit time-step or phase index is set to zero or one for alternate time-steps; for example, the bit is set to zero for even time-steps and to one for odd time-steps. Time progression is thus signaled by changes in the phase bit. Whenever a component in the processing system detects that the phase bit in incoming events has changed, it assumes that one full time-step has passed and the next time-step has begun. FIG. 5 illustrates how the progression of time is encoded as the phase bit transitions between 0 and 1.

Each component (e.g., event buses 115 and processing elements 120) is configured to prevent interleaving of events belonging to different time-steps or phases. Furthermore, every event producer (e.g., the host system, processing elements 120, and filters 125) is configured to produce at least one event per time-step. If there is no actual usable event in a given time-step, the event producer instead produces an “invalid event”, i.e. with a source ID of 0, as discussed above.

With this configuration, local phase synchronization can be achieved. Changes in the phase bit can be accurately interpreted locally because there is no interleaving, thus avoiding a lack of synchronization, mathematical errors, and/or whole-system stalls. Furthermore, with the event bus 15 operation as described above, events belonging to the same time-step are not mixed with events belonging to the next time step. The requirement for every producer to produce at least one event per time-step ensures that all input event ports 205 on the event bus 115 will enter the “stall” state, one of the conditions for a phase change in the event bus 115. This configuration does not require the event bus 115 to enforce the requirement that each event producer generate an event for each time-step. It will be appreciated by those skilled in the art that with this configuration, it is not necessary for the processing system 100 to employ a global controller to keep track of the progression of time. Provided time-steps are not skipped, changes in the phase bit can be safely interpreted locally without a global controller.

In the case where the host system is processing a finite time-series, the end of the series is capped by the host system injecting a series of empty time-steps with alternating phase to ensure that all events in the system are “flushed out”.

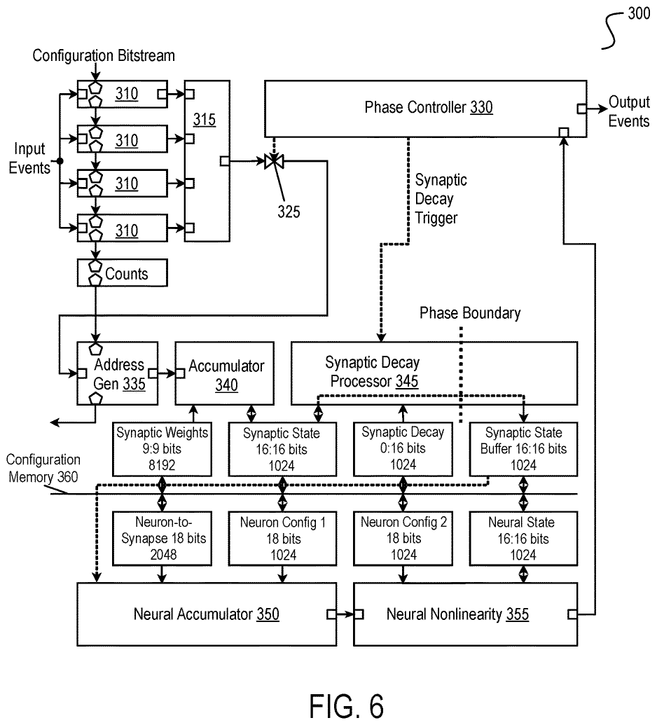

FIG. 6 depicts the high-level architecture 300 of an example processing element 120. The processing element, as discussed above, receives input events, and after some time, produces one or more output events for each time-step. The processing element may be considered as comprising “synaptic” input and “neural” output stages. The synaptic stage processes incoming events and modifies “synaptic states” depending on those events. Each synaptic state can have a different low-pass filter attached, for translating between temporally sparse and dense representations. One or multiple synapses can be connected to a single neuron. The neurons receive the sum of the connected synaptic states and are responsible for generating output events, and may comprise a linear pass-through, a rectified linear unit, or an integrate-and-fire neuron. In the latter case, the neuron itself possesses a neural state that is updated.

As data passes through a processing element 120, the phase of the output events is incremented by 1 relative to the input events (i.e., the phase bit is negated); that is, data “ages” by one time-step, or the processing element “consumes” one time-step when processing events, such that if the current input phase is 0, the output events influenced by those input events will have phase 1. This avoids stalling in the case of processing elements 120 that are recurrently connected; otherwise, recurrently connected processing elements could create an infinite number of events for a single time-step which may stall the entire system. If the processing elements 120 in the processing system 100 are connected in a purely feed-forward manner, this requirement could be removed from the hardware by making the “advance time” behaviour configurable on a per-processing element basis (e.g., by adding another bit to the configuration bitstream).

At a first step, input events entering the processing element are first filtered through filters 310. The filters 310 can be configured to select the events that the processing element should process further. In particular, the filters 310 match events against an axis-aligned “cube” in the space formed by the (id, x, y)-source address triples. More specifically, a user can specify two pairs of source addresses, namely (id₀, x₀, y₀) and (id₁, x₁, y₁). Only events that match the following expression are allowed to pass:

$$( {id}_{0} \geq id \geq {id}_{1} ) \hat{} ( {x}_{0} \geq x \geq {x}_{1} ) \hat{} ( {y}_{0} \geq y \geq {y}_{1} ) , \qquad ( 1 )$$

where “Λ” is a logical “AND”. Setting either id₀ or id₁ to the “invalid ID” 0 disables the filter.

Matched events are tagged with identifiers of their matching filters, then placed in an input FIFO buffer 315. Each filter 310 is tied to a corresponding address generator configuration. An event matched by a specific filter 310 implies that the event should be processed by the associated address generator. If an event matches multiple filters 310, then the event is processed multiple times with the corresponding address generator configurations. This is implemented by tagging each event with the filters 310 that matched before placing the event in the FIFO buffer 315. In the illustrated implementation, a 36-bit FIFO with 1024 entries is employed; in addition to each 32-bit event, four bits indicating the matching filters are stored. Additional filter bits may be provided by altering the event format or employing a wider FIFO; alternatively, the source ID bits (see FIG. 3) may be discarded, providing space for additional filter and address generator configurations.

From the user perspective, input events not matching any filter 310 are discarded. Internally to ensure local phase synchronization the first event belonging to each input time-step (the “first of its phase”) is pushed into the FIFO buffer 315, even if this event does not match any of the filters. In the example structure in FIG. 6, a gating mechanism 325 to ensure temporal coherence is provided after the buffer 315. Even if the gating mechanism 325 blocks events from passing into the remainder of the processing element, the processing element can continue to consume events from the event bus 115, and thus prevent (or at least delay) stalls of upstream components. However, to detect changes in phase and keep processing elements synchronised, at least one event per time-step must arrive at the gating mechanism 325. This can be achieved by permitting one event per time-step to pass onto the FIFO buffer 315 irrespective of any filter matches. Events not matching any input filter are then discarded in the address generator stage.

The address generator 335 determines, for a given input event, what synapses are affected, and how the input payload should be weighted. That is, for each input event, the address generator 335 generates a stream of tuples of the form (saddr, waddr). By performing this mapping from input events to target synaptic weights and states, the address generator 335 effectively determines how neuron layers are connected.

The synaptic state address saddr is the word index for the synaptic state memory that indicates where the synaptic state that should be updated is located. Similarly, waddr is the synaptic weight address, that is, the word index in the synaptic weight memory where the weight the input payload should be multiplied with is located.

The mapping from input events to target(saddr, waddr)-pairs depends on the address generator configuration and on whether the address generator is configured to implement a dense all-to-all connection, or a 2D convolution. Internally, address generation is split into two stages. The first stage is the “loop-parameter generation” stage, the second stage is the “loop iteration stage”. The two stages are pipelined: the second stage can prepare the next set of loop-parameters while the first stage is active.

The loop parameters have the form

(saddr_offs, saddr_incr0, saddr_incr1, waddr_offs, waddr_incr0, waddr_incr1,
iter_count0, iter_count1)

which are general enough to support both the memory access patterns required for dense connections and for two-dimensional convolution. The loop iteration stage emits state and weight addresses, for example as defined in Table 2 below (expressed in Python code):

TABLE 2
Loop iteration.

```
saddr_cntr0 = saddr_offs
waddr_cntr0 = waddr_offs
for _ in range(iter_count0):
  saddr_cntr1 = 0
  waddr_cntr1 = 0
  for _ in range(iter_count1):
    yield (saddr_cntr0 + saddr_cntr1), (waddr_cntr0 + waddr_cntr1)
    saddr_cntr1 += saddr_incr1
    waddr_cntr1 += waddr_incr1
  saddr_cntr0 += saddr_incr0
  waddr_cntr0 += waddr_incr0
```

where the loop increments saddr_incr0, saddr_incr1, waddr_incr0, waddr_incr1 are signed integers; in other words, addresses can both increment and decrement. The loop iterator can emit one (saddr, waddr)-pair per cycle; the two nested loops are required to realise iteration over a two-dimensional synapse grid.

The loop parameters are computed by passing the source addresses through a micro-program-controlled arithmetic logic unit configured for both dense connections and 2D convolution. For a dense connection, the address generator 335 may generate parameters following the high-level process depicted in Table 3:

TABLE 3
Loop parameter generation for dense connections.

# Compute how the weight address changes for each increment in source
# x- or y- coordinate
src_x_stride = src_height * tar_width * tar_height
src_y_stride = tar_width * tar_height
# Select the corresponding slice in the 4D synaptic weight tensor
waddr_offs = src_x_stride * src_x + src_y_stride * src_y
# Iterate over the weight tensor; assume weights are stored
# in a column-major format.
waddr_incr0 = tar_height
waddr_incr1 = 1
# Iterate over all available target synapses
saddr_offs = 0
saddr_incr0 = tar_height
saddr_incr1 = 1
iter_count0 = tar_width
iter_count1 = tar_height

where src_height, src_width, tar_height, tar_width are the shapes of the source and target population, respectively, while src_x and src_y are the coordinates of the source event.

For a convolution connection, the address generator 335 may generate parameters following the high-level process depicted in Table 4:

TABLE 4
Loop parameter generation for convolutions.

# Compute the kernel coordinates to iterate over; first compute the
# kernel coordinates that result in the corresponding target index
# being equal to tar_width − 1 / tar_height − 1
kx0 = max(0, src_x + pad_x − ((tar_width − 1) << cx))
ky0 = max(0, src_y + pad_y − ((tar_height − 1) << cy))
# Now round up to the nearest kx/ky such that the computation of
# tx/ty below does not have a remainder
kx0 += (src_x + pad_x − kx0) & ((1 << cx) − 1)
ky0 += (src_y + pad_y − ky0) & ((1 << cy) − 1)
# Compute the initial target coordinates
tx0 = (src_x + pad_x − kx0) >> cx
ty0 = (src_y + pad_y − ky0) >> cy
# Compute the maximum possible kernel address
kx1 = min(kernel_width, src_x + pad_x + 1)
ky1 = min(kernel_height, src_y + pad_y + 1)
# Iterate over the kernel starting from the kx0, ky0 address.
# Skip weights according to the stride.
waddr_offs = kernel_height * kx0 + ky0
waddr_incr0 = kernel_height << cx
waddr_incr1 = 1 << cy
# Iterate backwards over the target pixels
saddr_offs = tar_height * tx0 + ty0
saddr_incr0 = −tar_height
saddr_incr1 = −1
# Round the iteration count to the stride size
iter_count0 = max(0, (kx1 − kx0 + ((1 << cx) − 1)) >> cx)
iter_count1 = max(0, (ky1 − ky0 + ((1 << cy) − 1)) > cy)

where kernel_width and kernel_height describe the size of the convolution kernel, pad_x and pad_y are used to implement different padding modes, and cx and cy are the log₂ of the “contraction sizes” used to implement different strides.

The transformation takes about 10 cycles for dense connections and about 80 cycles for convolution connections. Loop parameter generation is discussed in further detail below.

The synaptic accumulator 340 takes the (saddr, waddr)-pairs produced by the address generator 335, and performs the operation

$$synaptic\_state [ saddr ] += payload ⋆ synaptic\_weight [ waddr ]$$

to accumulate weights for the corresponding event.

For this computation, the synaptic weight is stored in memory as an 18-bit signed fixed-point number with a 9-bit fractional part, and the synaptic stage is stored as a 32-bit signed fixed-point number with a 16-bit fractional part.

The synaptic decay stage is triggered at the end of each time-step, and is executed once per time-step. The synaptic decay processor 345 performs two actions: first, it copies the current content of the synaptic state memory to the synaptic state buffer, and second, it performs the synaptic decay step. The synaptic decay is implemented by multiplying the synaptic state with a user-configurable decay variable, for example:

for saddr in range(n synapses):

$$synaptic\_state \_buf [ saddr ] = synaptic\_state [ saddr ]$$

$$synaptic\_state [ saddr ] *= synaptic\_decay [ saddr ]$$

In the implementation discussed here, the synaptic state and synaptic state buffer are 32-bit signed fixed-point numbers with 16-bit fractional resolution and the synaptic decay is a 16-bit unsigned fixed-point number with 16-bit fractional resolution.

The synaptic_decay parameter may be computed in such a manner that the hardware implements a low-pass filter with a particular time constant τ. By way of background, the filter kernel h(t) is typically defined as

$$h ( t ) = \{ \begin{matrix}\frac{1}{τ} exp ( - \frac{t}{τ} ) & if t \geq 0 , \\ 0 & otherwise\end{matrix} \qquad ( 2 )$$

The scaling factor 1/τ is chosen to ensure that the integral of h(t) is one, i.e., the filter is energy-preserving. The corresponding continuous-time linear time-invariant system is

$$\frac{d}{dt} x ( t ) = Ax ( t ) + Bu ( t ) where A = - \frac{1}{τ} , B = \frac{1}{τ} . \qquad ( 3 )$$

This system could be mapped onto the synaptic decay operation implemented by the hardware using Euler integration. With Δ as the time-step size, i.e., the time passing between two time-steps, the following update rule can be obtained:

$${x}_{t + 1} = {x}_{t} + Δ ( {Ax}_{t} + {Bu}_{t} ) = {A}^{′} {x}_{t} + {B}^{′} {u}_{t} \qquad ( 4 )$$

where A′ is 1+ΔA, and B′ is ΔB. The expression A′ is equal to the value of synaptic_decay. Alternatively, however, synaptic_decay parameter may be based on the update equation:

$${x}_{t + 1} = {A}^{′} {x}_{t} + {B}^{′} {u}_{t} where {A}^{′} = exp ( - \frac{Δ}{τ} ) and {B}^{′} = \frac{Δ}{τ} . \qquad ( 5 )$$

Using the exponential for A′ ensures that the impulse response of the discrete time system perfectly follows the desired filter impulse response h(t) evaluated at t=Δi for integer i. FIG. 7 illustrates the impulse response for synaptic filters with different time-constants τ and employing the different discretization methods discussed above. Graph (A) illustrates continuous time filter h(t); graph (b) depicts naïve Euler discretization for a time-step of Δ=40 ms. For smaller r this way of determining the synaptic decay constant is imprecise and may eventually result in instabilities. Graph (C) illustrates the third discretization method employing the exponential for A′; it can be seen that the impulse response of the discretized system exactly matches the continuous time filters h(t) evaluated at Δi.

The scaling factor

$${B}^{′} = \frac{Δ}{τ}$$

is appropriate for processing non-spiking data. For spiking data, a scaling factor of

$${B}^{′} = \frac{1}{τ}$$

may be used instead: in the implementation discussed here, a value of 1 is used to represent a positive spike, although the value is expected to be 1/Δ to approximate a Dirac delta with energy=1. However, the 1/Δ cancels the Δ in Δ/τ so using 1 to signal a spike event and to skip the scaling factor is mathematically equivalent.

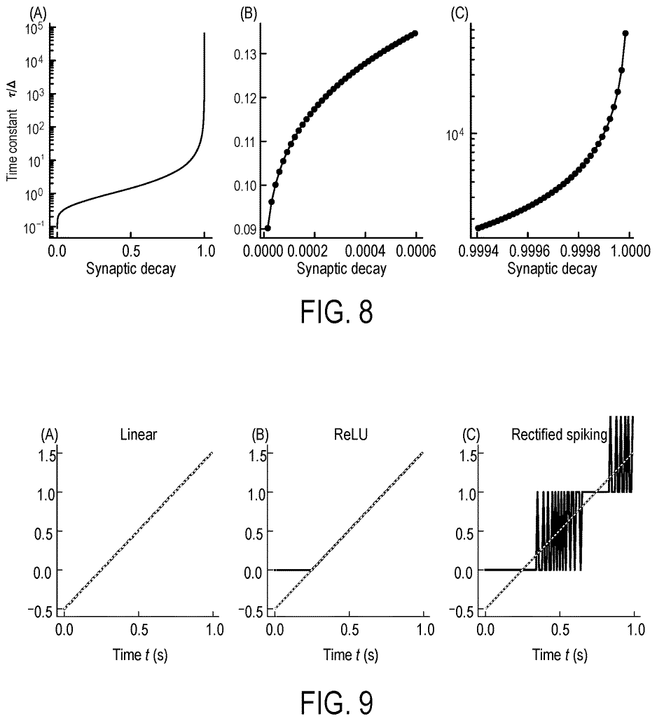

It will be understood by those skilled in the art that when sweeping over τ, A′ can quickly approach values near 1; correspondingly, depending on Δ, a large portion of the dynamic range of synaptic_decay is wasted on extremely small τ. However, the provided 16-bit fractional resolution is sufficient to represent a large range of possible time constants τ. FIG. 8 illustrates synaptic time-constants representable in the processing system 100 with a mapping

$$\frac{τ}{Δ} = \frac{- 1}{log {A}^{′}} .$$

The x-axis depicts the 16-bit synaptic_decay value A′ and the y-axis the achievable time constant τ divided by the time-step Δ (e.g., for Δ=1 ms all values on the y-axis are in milliseconds). Synaptic time constants below 1 or above 100 can only be expressed with limited precision. Graph (A) depicts mapping from A′ onto time constants over the entire range of possible A′ Graphs (B) and (C) illustrate mapping for the first and last 40 representable synaptic decay values, where each dot is one possible synaptic_decay value.

Returning to FIG. 6, processes in the processing element 120 are controlled by the phase controller 330, which tracks the phase of incoming events, prevents events belonging to the next time-step from influencing the synaptic state, and triggers the synaptic decay process. The phase controller 330 triggers a synaptic decay once the following three conditions are met: the input event pulled from the FIFO buffer 315 is stalling at the input gate 310; the synaptic accumulator 340 is not active; and the neural accumulator 350 is not active.

After a synaptic decay has been triggered, the phase controller 330 waits for the synaptic decay to complete. Once that is done, the phase controller 330 transitions the input gate(s) 310 to the next phase and triggers the neural accumulator 350. The phase controller then returns to its default state of waiting for the three conditions listed above to be fulfilled.

The phase controller 330 also ensures that local phase synchronization is fulfilled by inserting at least one event per time-step into the output stream, even if the neural output stage does not produce any events (because all neural activities are zero or the neuron count is zero). Rather than waiting for the neural output stage to be complete, the phase controller 330 may pre-emptively insert an “invalid” event into the output stream just when the neural output stage is triggered.

Additionally, an “invalid” output event for phase “1” is inserted into the output stream directly after reset; this ensures that all consuming “event bus” instances are primed with at least one event per input channel. Otherwise, and particularly in conjunction with recurrently connected PEs, there may be a deadlock, where the event bus waits for stalling input events to send more events to connected components. At the same time, for those events to be generated, the PE waits for a phase transition at its input side.

The neural accumulator t sums all inputs connected to a neuron. This includes synaptic inputs, as well as the bias value configured for each neuron. As high-level Python code, the behaviour of the neural accumulator can be expressed as set out below in Table 5:

TABLE 5
Neural accumulator summation.

```
for neuron_idx in range(n_neurons):
  accu = neuron_config1[neuron_idx].bias
  for synapse_idx in range(neuron_to_synapse_map[neuron_idx]):
    accu += synaptic_state_buffer[synapse_idx]
  yield accu, neuron_idx
```

The bias value is stored as a 12-bit signed number with an 8-bit fractional part. The “neuron to synapse map” encodes up to two source synapse ids in an 18-bit word. As a final step, the accumulated weight value is sent to the neural nonlinearlity processor 355, the output stage of the processing element 120. The neural nonlinearlity processor 355 takes the accumulated synaptic input from the neural accumulator 350, applies the neural nonlinearity, and emits an optimal series of output events.

In particular, with reference to FIG. 9, in this example the neural nonlinearlity processor 355 implements three different kinds of neural processing. A neuron can be linear (i.e., a pure pass-through unit), a rectified linear unit (ReLU), or a spiking rectified unit (sometimes also referred to as “integrate-and-fire”). In FIG. 9, the dashed line represents input fed into the neuron over time, and the solid black line is the output; the “wiggly” appearance of the black line is due to discretization. In graph (A), the “linear” neuron simply acts as a pass-through node; the dashed and solid lines coincide. In graph (B), the “ReLU” neuron applies rectification to the input, such that values below zero are mapped to zero. In graph (C), the “rectified spiking” neuron applies rectification to the input, and only emits an integer portion of the current neural state. The fractional portion is integrated over time, similar to a ΔΣ-modulator. This results in a spiky output pattern for inputs smaller than one; the output in the graph is simulated at a time-step of 10 ms.

Since events with a null payload are not emitted, the “rectified spiking” neuron acts as a kind of temporal “sparsification”. Typically, a main purpose of the “spiking” neuron type is to provide sparsification, such that the neuron is silent for as many time-steps as possible. As can be seen from FIG. 9, sparsification occurs when the input to the neuron is relatively small; correspondingly, synaptic weights should be small as well. Depending on the particular application of the processing system 100, a fixed scaling factor (e.g. 1/1024) may be added to the input of rectified spiking neurons in the neural nonlinearity processor 355, which would make better use of the synaptic weight dynamic range when constructing spiking neural networks.

Assuming that the neural nonlinearlity processor 355 receives an accu, neuron_idx pair from the neural accumulator 350, the high-level behaviour of the neural nonlinearlity processor 355 can be modelled as set out in Table 6:

TABLE 6
Neural nonlinearity processor behaviour.

```
if neuron_kind[neuron_idx] == RECTIFIED_SPIKING:
  # Accumulate previous neural state (Sigma)
  accu += neural_state[neuron_idx]
if ((neuron_kind[neuron_idx] == RELU) or
  (neuron_kind[neuron_idx] == RECTIFIED_SPIKING)):
  # Implement rectification
  accu = max(0, accu)
if neuron_kind[neuron_idx] == RECTIFIED_SPIKING:
  # Emit the integer portion as events
  emit_events(floor(accu), neuron_idx)
  # Store the fractional portion (Delta)
  neural_state[neuron_idx] = frac(accu)
else:
  emit_events(accu, neuron_idx)
```

where neural_state and accu are 32-bit signed numbers with 16-bit fractional portion. The emit_events function also implements the splitting of the given payload into a series of events as discussed above.

Returning to FIG. 1, readout filters 125 are employed to select events that should be sent back to the host system so that the final result of the computation performed by the processing system 100 can be read, and to attach “debug probes” to different parts of the system.

Zero, one, or more filters may be provided in a given stage of the processing system 100. In the example implementation in FIG. 1, every event bus 115 except for the first is connected to two readout filter 125 instances. The configuration and computation of the readout filter 125 is similar to that of the processing element input filter discussed above. Each filter 125 matches events against an axis-aligned “cube” in (id, x, y)-source address space. Given two pairs of source addresses (id₀, x₀, y₀) and (id₁, x₁, y₁), only events that match the expression (1) are allowed to pass.

In contrast to the filters 310 in processing element (as shown in FIG. 6), the readout filter 125 can also be used to rewrite the source ID of the events sent back to the host system. This is useful if source ids are re-used across event buses 115; source ID rewriting can then be used to determine which readout filter 125 an event originated from.

More specifically, each readout filter 125 has a

$${id}_{0}^{tar}$$

configuration word that is used to rewrite the output source ID. The readout filter 125 transforms the source ID of each event as follows:

$${id}^{′} = id - {id}_{0} + {id}_{0}^{tar} \qquad ( 6 )$$

Setting

$${id}_{0}^{tar}$$

to the “invalid ID” 0 value disables the readout filter 125. However, the readout filter 125 still permits invalid events to pass through, whether it is disabled or not, to enable local phase synchronization discussed above. Since every processing element creates at least one invalid event per phase, also as discussed above, each readout filter 125 also therefore outputs at least one event per phase.

Continuing with FIG. 1, the processing system 100 has at least two connections to the CPU of the host system for both the incoming event data (a “stream interface”) and control registers (the “register interface” 105). Typically, the register interface 105 is used to configure the processing system 100 while it is in an idle mode, and the stream interface is used to send and receive AER events while the processing system 100 is in an active mode.

In the implementation discussed here, configuration of the processing system 100 is controlled by four memory-mapped 32-bit registers, a control and status register (CSR), a configuration bitstream data register (CBDR), a configuration memory data register (CMDR) and a configuration memory address register (CMAR). These registers may be mapped into the host CPU memory at a base address for the processing system 100, with each register is offset by four bytes.

The CSR provides high-level information about the current status of the processing system 100, and can be used to reset, start, and stop the processing system 100. It is also responsible for signaling the availability of data on the stream interface. Table 7 sets out possible status and control bits in the CSR:

TABLE 7
Control and status register configuration.

| Bit | Read/Write | Name | Description |
|---|---|---|---|
| 0 | read-only | IDLE | Indicates whether processing system 100 is |
| (LSB) | | | currently in “idle mode” (1) or “active mode” (0). |
| | | | Write to the START and STOP bits to transition the |
| | | | register interface to active mode or back to idle |
| | | | mode. |
| 1 | read-only | BUSY | Asserted by the processing system 100 if any of the |
| | | | processing elements are still processing data. This |
| | | | bit can only be asserted during “active mode”. |
| 2 | read-only | HAS_DATA | Asserted by the processing system 100 whenever |
| | | | data is available in the output stream packetizer. |
| | | | Every time this bit is set, the |
| | | | OUTPUT_TRIGGER_READY bit will be set as well. The |
| | | | bit is deasserted as soon as there is no data left in |
| | | | the stream packetizer. |
| | | | Only asserted during “active mode”. Transitioning to |
| | | | the STOP state requires HAS_DATA to be deasserted; |
| | | | that is, all data is pulled out. |
| 3 | read-only | CFG_DONE | Asserted by the processing system 100 whenever the |
| | | | configuration chain has been filled. The value of this |
| | | | bit is trusted when CFG_BUS_READY is asserted as |
| | | | well. Reset by asserting RESTART_CFG. |
| 4 | read-only | MEM_BUS_READY | Asserted by the processing system 100 if the current |
| | | | read-value of the memory bus data register reflects |
| | | | the value at the address specified by the memory bus |
| | | | address register. Whenever the address register |
| | | | changes, this bit is deasserted for a number of cycles; |
| | | | once the new address is known to have reached all |
| | | | devices on the bus, and their output has propagated |
| | | | back to the register interface, this bit is re-asserted. |
| | | | Note that this bit is only relevant for reading; when |
| | | | reading from an address, always wait for this bit to |
| | | | be asserted. Writes do not require any waiting. |
| | | | This bit can only be asserted during “active mode”. |
| 5 | read-only | CFG_BUS_READY | Asserted once the CFG_DONE bit is known to be |
| | | | correct after a reset or shift operation on the |
| | | | configuration chain. This bit can only be asserted |
| | | | during “active mode”. |
| 6 | n/a | n/a | Reserved. |
| 7 | read-write | STOP | When asserted by the user, the processing system |
| | | | 100 transitions from “active” to “idle mode”. When |
| | | | read by the user, returns one if the processing |
| | | | system 100is currently in the process of |
| | | | transitioning to “idle mode”. The transition can only |
| | | | complete once HAS_DATA is deasserted. |
| 8 | read-write | START | When asserted by the user, the processing system |
| | | | 100transitions from “idle” to “active mode”. When |
| | | | read by the user, returns one if the processing |
| | | | system 100 is currently in the process of transitioning to |
| | | | “active mode”. The transition process requires a fixed |
| | | | number of cycles to ensure that all internal |
| | | | components are in a valid state. |
| 9 | write-only | RESTART_CFG | When asserted by the user, resets the configuration |
| | | | chain. This means that counter responsible for |
| | | | asserting the CFG_DONE flag will be reset to zero. |
| | | | This counter is in an undefined stage after reset, the |
| | | | configuration chain must be reset for any When |
| | | | writing to this bit, wait for CFG_BUS_READY before |
| | | | interpreting CFG_DONE. |
| 10 | read-write | RESET | When set to one, triggers a reset of the processing |
| | | | system 100 hardware. Note that this will not reset |
| | | | the stream interface (i.e., neither the stream receiver, |
| | | | nor the stream packetizer) to ensure that the DMA |
| | | | controller will not be interrupted. Cancel any |
| | | | outstanding input DMA transaction before resetting, |
| | | | and pull all data that might still be available out of |
| | | | the system after performing a reset. After reset, the |
| | | | hardware will be in “idle mode”. Reads as “one” once |
| | | | the reset is done. Reset requires a fixed number of |
| | | | cycles. |
| 11 | read-write | OUTPUT_TRIGGER | Asserted by the processing system 100 if the output |
| | | | rigger is ready, that is, a new output DMA transaction |
| | | | can be started by the stream packetizer. The user |
| | | | must confirm that a new DMA transaction should be |
| | | | started by writing a one to this bit. This bit can only |
| | | | be set by the hardware the hardware is in “active |
| | | | mode”. |

Writing 32-bit word to the CMDR in “idle mode” will update up to 32 bits of memory in the currently selected configuration memory word. Configuration memory words are selected through the CMAR register. Every write to CMDR automatically increments CMAR by one. Correspondingly, an entire region of memory can be updated quickly by sequentially writing words to the CMDR register. The CMDR can also be used to read the current content of the configuration memory; however, the contents of the CMDR register are only valid if the MEM_BUS_READY bit is set in the CSR. This bit indicates that reading from the CMDR will actually return the data at the address indicated by CMAR. While the CMDR is a 32-bit register, writing to this register will not necessarily update 32 bits. For example, if CMAR points at the synaptic weight memory, CMDR will refer to a single 18-bit word. Similarly, CMAR selects individual memory words, such that incrementing CMAR by one will skip to the next 18-bit word.

As can be appreciated from FIG. 1, the configuration scan chain passes through all processing elements 120 and then filters 125. Thus, in the configuration bitstream, the configuration data for all processing elements 120 attached to a given source event bus 115 is followed by the configuration data for all filters 125 reading from that bus 115. Configuration data for each processing element 120 includes both address generator configuration data for configuring the associated address generator 335 (see FIG. 6), as well as configuration data for the number of synapses and neurons employed by the processing element 120.

Each processing element 120 takes both processing element configuration data defining the number of synapses and neurons, as well as address generator configuration data. The latter supports the two stages of address generation discussed above, which takes variables set in the address configuration data as input. Additionally, the address generator configuration data can include a generator mode field that is used to switch the address generator between “dense” and “convolution” mode. Each readout filter 125 takes address configuration data. In a typical implementation, the configuration bitstream comprises a series of octets that can be written to the processing system 100 through the CBDR when the processing system 100 is in “idle” mode.

Returning to FIG. 6, it can be seen that the configuration memory 360 of each processing element 120 comprises eight different configuration memory regions: synaptic weights, synaptic states, synaptic decay, the synaptic state buffer, the neuron-to-synapse map, neuron configuration 1, neuron configuration 2, and the neural states. In turn, the configuration memories 360 of all processing elements 120 are mapped into a global address space. This global address space can be accessed through CMDR and CMAR while the hardware is in “idle mode” as set out above. The 32-bit memory addresses are split into two parts: the upper 16 bits are the “memory bank selector”, whereas the lower 16 bit are the “word selector”. Memory bank selector indices are consecutive between processing elements 120; the bank selector index of the first configuration memory of the second processing element directly follows the bank selector index of the last configuration memory of the first processing element, and so on. In the implementation discussed here, the configuration memory regions may be defined as follows:

Synaptic weight memory. Each word in the synaptic weight memory is a signed 18 bit number with a 9 bit fractional component. In this example implementation, each processing element 120 has access to 8192 synaptic weights. Synaptic weights are used to store both convolution kernels and dense weight matrices. The waddr_offs configuration word in the address generator specifies the location of the first synaptic weight.

Synaptic state memory. Synaptic states are signed 32 bit numbers with a 16 bit fractional component. In this example implementation, the processing element 120 has access to 1024 synaptic states. The synaptic state memory is used to both as a “scratch buffer” for accumulating events, and as the state of the low-pass filter associated with each synapse.

Synaptic decay memory; The synaptic decay memory configures the low-pass filter applied to the synaptic state. Each word in the synaptic decay memory is an unsigned 16 bit number with a 16 bit fractional component. Each processing element 120 has access to 1024 synaptic decay values, one for each synaptic state.

The synaptic state memory buffer is a double-buffer of the synaptic state used to decouple synaptic and neuronal processing, with the same layout and size as the synaptic state memory.

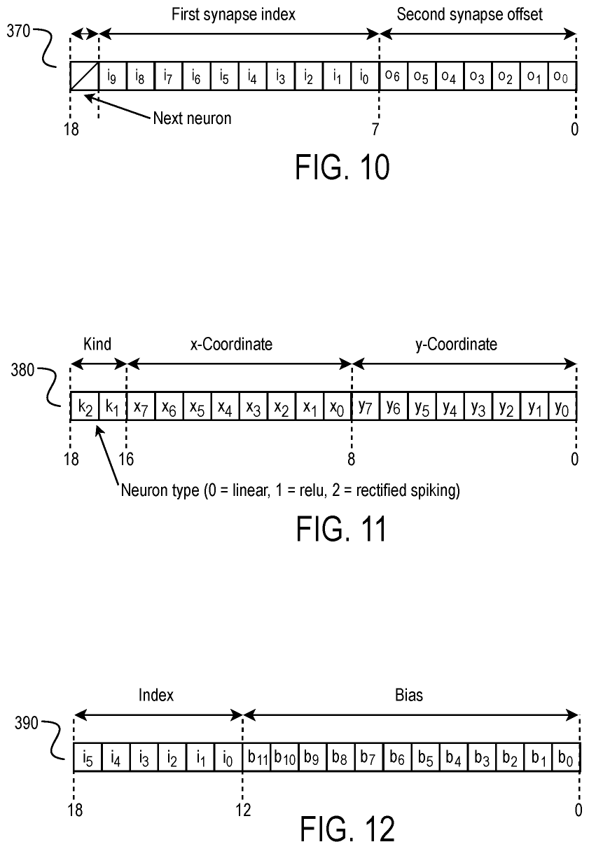

Neuron-to-synapse map. The neuron-to-synapse map is used to assign synapses to neurons. In other words, the neuron-to-synapse map determines what synapses are accumulated when computing the neural input; the map may permit any neuron to receive input from any synapse, and vice-versa. This memory uses up to 2048 18-bit words. Each word efficiently encodes up to two synapses belonging to a neuron, as depicted in the scheme 370 shown in FIG. 10. If the most significant bit is set, then the current neuron index is incremented; otherwise the synaptic state belonging to the encoded synapses is added to the neural state of the current neuron. The first synapse index is an absolute reference to a synaptic state, while the second synapse offset is a relative offset to the first one: an offset of zero indicates that this field is unused. In the example implementation discussed here, the neuron-to-synapse map terminates with a word with the “next neuron” flag set because the processing element iterates over the neuron-to-synapse map until the current neuron index is equal to the number of neurons encoded in the processing element's configuration data. This is not an issue when all 2048 available entries are used for the mapping; but if the index is not reached, it continues to interpret the entries in the neuron-to-synapse map as valid neuron-to-synapse mappings.

Neuron configuration 1. The first neuron configuration memory contains 1024 18-bit words describing each neuron in more detail, as set out in the scheme 380 shown in FIG. 11. In particular, this configuration memory stores the neuron type using two bits as well as the neuron x- and y-coordinates attached to all events emitted by this neuron using 8 bits each.

Neuron configuration 2. The second neuron configuration memory contains 1024 18-bit words containing further information about each neuron, as shown in the scheme 390 in FIG. 12. In particular, this configuration memory stores the source ID attached to all events emitted by this neuron, as well as a 12-bit signed bias value with an 8 bit fractional component that is added as a constant to each neuron's input in every cycle.

Neural state. The neural state memory is only relevant for spiking rectified neurons. This memory contains 1024 signed 32-bit words with a 16-bit fractional component. Each word is used to store the accumulated sub-threshold activation of the spiking neuron.

The configuration memory 360 can also include read-only memory for hardware identification and verification purposes.

Referring again to FIG. 1, the stream interface for the processing system 100 comprises the stream receiver 110 and stream packetizer 135 components. The stream receiver 110 prevents any DMA transaction from starting while the processing system 100 is in “idle” mode, and ensures that any active stream transactions can complete, even if the processing system 100 is transitioning to “idle” mode by waiting for the “last” flag in the stream interface (not shown) to be asserted before the receiver 110 stops handling input events.

The stream packetizer 135 is responsible for the OUTPUT_TRIGGER bit in the register interface 105, discussed above, and periodically generates a “last” signal for use by a downstream DMA controller to indicate that the word is the “last of a transaction”. The “last” signal is generated in two circumstances: when an output transaction is active, but there is a timeout because the output event bus 130 has not produced any new events for the last few hundred clock cycles (depending on the definition of a timeout); and when an output transaction is active, but a maximum packet size has been reached.

As is evident from the discussion above, the processing system 100 makes use of both external and internal stream interfaces for communication of both event and configuration data. Components connected through “stream ports”-ports 116, 118 in FIG. 1, for example—can “produce” for an output port) or “consume” (for an input port) data at any rate. Such a latency invariant design permits individual modules to be independently testable, as there is no need as there is no need for components to meet specific timing requirements—data only flows whenever there is a “handshake” between the producer and consumer. Furthermore, such a system makes pipelining trivial. Consumers can perform computations while they are waiting for a producer to produce a new piece of data.

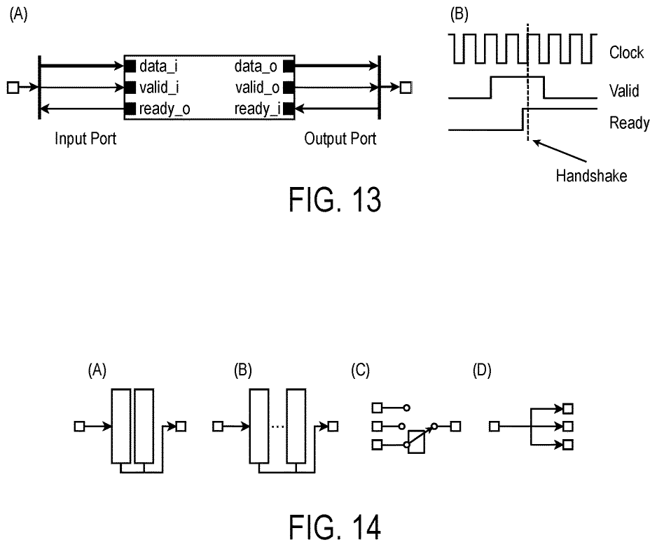

FIG. 13 illustrates the internal stream interface used to connect most components in the processing system 100. Data transported through internal stream interfaces is accompanied by a “valid” and a “ready” signal. A producer asserts the “valid” signal to indicate that the data is currently valid. Independently, a consumer indicates that it is ready to receive data by asserting the “ready” signal. As shown in (A), on the input side, a component accepting data through a stream interface requires a data input (this may be an array of signal lines, depicted here using a thicker arrow), an input for the “valid” flag, and an output for the “ready” flag. Input and output directions are reversed for the output port. With reference to (B), data is “consumed” whenever there is a stream handshake, that is, both “valid” and “ready” are asserted during a rising clock edge.

The internal stream interface is implemented using a number of primitive stream components, namely a skid buffer, FIFO buffer, stream arbiter, and stream splitter. With reference to FIG. 14, (A) depicts a skid buffer, sometimes also referred to as “Carloni” buffer. The skid buffer implements a stream pass-through with a single input and output port. In the implementation discussed here, the throughput of the component is one word per cycle, with a typical latency of one cycle. There is no combinatorial connection between the input and the output—instead, the output is fully registered. In other words, the input or output side of the skid buffer are combinatorially decoupled and can perform complex combinatorial computations without affecting the maximum frequency of the previous component. As such, skid buffers are useful in building pipelined designs, where several modules work together to implement a complex computation in sequence. The skid buffer can also be considered as a two-element FIFO, implemented using two registers. This is the minimum number of registers for this task; implementations with a single register can only reach throughputs of half a word per cycle. Typically, in the processing system 100 skid buffers are placed at the output side of a module.

The FIFO buffer, shown in FIG. 14 (B), is similar to the skid buffer in that it decouples the input- and output-side of a stream interface, maintaining the order of the incoming words. It has the same interface as the skid buffer—an input and an output stream port. In the processing system, FIFO buffers are typically used to “absorb” data from producers producing data in bursts with high rates (e.g., the output side of a processing element) that are connected to the input of a component that can only consume events at lower rates (e.g., the input side of a processing element). By placing an appropriately sized FIFO in between the two components, the FIFO ensures that the producer can finish producing data (and start working on a next task), while the consumer is working on the received items. In this example implementation, the FIFO buffer is manually constructed around a SRAM block with power of two size. The size of the FIFO is forced to be a power of two so that the FIFO can be easily implemented as a ring-buffer, taking advantage of the implicit modulus arithmetic of a fixed-width integer. Further, the internal read and write pointers are one bit wider compared to what would be required. This enables distinguishing between the “full” and “empty” state by comparing the MSB. Since the SRAM has a latency of one cycle, a state machine and an additional output data buffer are employed to reach the maximum possible throughput of one word per cycle. A FIFO buffer is placed in each processing element 120 after the input filter, as well as directly before the stream packetizer 135. This latter FIFO buffer ensures that as much data as possible is “pulled” out of the output event bus 130, even if there is no output DMA transfer pending at the moment. Without this buffer, the processing elements would stall whenever there is no output DMA transaction running.

The stream arbiter, shown in FIG. 14 (C), is used to connect multiple stream producers to a single consumer. In the event bus 115, as can be seen in FIG. 2, stream arbiters receive events from the processing element output side; one processing element is connected to consumers at a time. As shown in FIG. 2, in the processing system 100 a N-to-1 arbiter is split into a binary tree of two-way arbiters 200. The two-way arbiter 200 keeps track of the last selected producer; if both producers are available, it prefers the other producer. The resulting arbiter tree is not fair for non-power-of-two N (i.e., producers are not necessarily treated equally with access to consumers), since not all producers are connected through the same number of two-way arbiters. While fairness could be enforced by weighting preferences for upstream producers, this may substantially increase the resources required to implement stream arbiters; and in typical implementations of the processing system 100, fairness is a lesser concern since the events of all producers are consumed.

The stream splitter may be thought of as the conceptual opposite of the stream arbiter, in that it connects a single producer to N consumers as shown in FIG. 14 (D). A splitter 225 forms the output stage of the event bus as shown in FIG. 2. A word presented at the input stream interface is consumed once all consumers have acknowledged the consumption of the word. This is implemented with a skid buffer for each output port. The input stream is gated on all skid buffers being “ready” simultaneously.

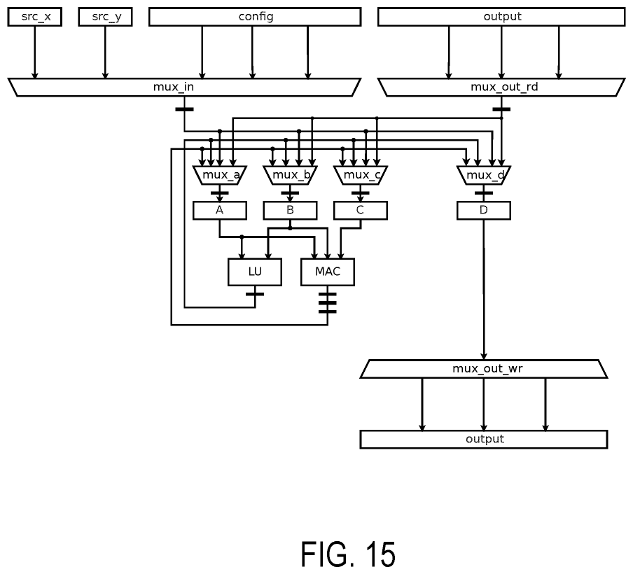

Returning to the address generator 335 in the processing element 120, the generator 335 comprises two major components: the loop parameter generator, and the loop iterator. The loop iterator is relatively simple to implement: in operation, it receives loop parameters through a stream interface, validates them, and implements two nested for loops using a simple state machine. The loop parameter generator, on the other hand, is more complex and temporally multiplexed. An arithmetic logic unit (ALU) is used to perform the individual operations described above and is depicted in FIG. 15. The flow of data is controlled using a micro-program, as mentioned above. A number of possible input sources are provided at the top of the diagram, including includes the event source x- and y-location, the address generator configuration registers (abbreviated as “config”), and the fed-back loop-parameter output. The computation performed by the ALU is controlled through seven multiplexers/demultiplexers, as well as a write-enable control signal and a logic-unit operation signal (write-enable and logic-unit signals are not shown in FIG. 15). The input multiplexer “mux_in” selects either a configuration word or the source x- and y-location. The output read multiplexer “mux_out_rd” selects one of the loop-parameter values as an input; the output write demultiplexer “mux_out_wr” determines which loop-parameter should be updated. Lastly, the multiplexers mux_a, mux_b, mux_c, mux_d what input should be routed to the arithmetic and logic units, as well as the output. The logic unit (LU) performs operations such as logical “AND” as well as right-shift operations with a latency of one cycle. The multiply-accumulate-unit (MAC) performs the fixed computation a×b+c with a latency of three cycles. The short horizontal bars following the multiplexers, LU, and MAC represent register boundaries (i.e., one clock cycle passes between the top- and bottom of the black bar).

The processing system 100 and its individual components may be implemented in any suitable host computing system using any suitable non-transitory or hardware components. For example, the embodiments discussed above may be implemented using commercially available logic chips and other components; in an application-specific integrated circuit (ASIC), or on a suitable FPGA platform such as the Xilinx® ZYNQ® or ZYNQ UltraScale+® series of FPGAs. In such an implementation, the processing system 100 is preferably configured to communicate with the host system using the Advanced eXtensible Interface (AXI) and AXI Stream communication protocols, although internal communications within the processing system 100 may diverge from these protocols.

It should be understood that this description is not intended to be limiting, and that the example implementations contemplated herein include all alternatives, modifications, and equivalents as would be appreciated by the person skilled in the art, and are included within the scope of the accompanying claims. Although features and elements of various examples or embodiments have been described as being in particular combinations, the person of ordinary skill in the art will appreciate that individual features or elements can be used alone, without the other features and elements of the embodiments, or in various combinations with or without other features and elements disclosed herein. For example, various components such as the event bus 115, processing element 120, address generator 340, or neural nonlinearity processor 355 may be implemented separately in a neural network processing system having a different architecture and components than the architecture generally described above.

Use of any particular term or language should not be construed as limiting the scope or requiring experimentation to implement the claimed subject matter or embodiments described herein. Any suggestion of substitutability of the data processing systems or environments for other implementation means should not be construed as an admission that the invention(s) described herein are abstract, or that the data processing systems or their components are non-essential to the invention(s) described herein.

A portion of the disclosure of this patent document contains material which is or may be subject to one or more of copyright, design patent, industrial design, or unregistered design protection. The rights holder has no objection to the reproduction of any such material as portrayed herein through facsimile reproduction of the patent document or patent disclosure, as it appears in the Patent Office file or records, but otherwise reserves all rights whatsoever.

1. A hardware-based processing system for event-based processing of neural networks, the processing system comprising:
a plurality of event buses and a plurality of processing elements provided in a plurality of stages, each stage comprising:
an event bus configured to receive events from one or more event producers and to output the events to one or more event consumers connected to the event bus, and
one or more processing elements connected to the event bus, the one or more processing elements configured to process a received event in synaptic input and neural output stages to generate an output event;
the event bus in each subsequent stage of the plurality of stages connected to the one or more processing elements of a previous stage of the plurality of stages such that the event bus in the subsequent stage is configured to receive the output event generated by the one or more processing elements of the previous stage; and
an output bus for receiving output events generated by the one or more processing elements of a final stage of the plurality of stages.

2. The processing system of claim 1, further comprising, in at least one stage of the plurality of stages, at least one filter connected to the event bus of that stage and configured to filter output events from the final stage of the plurality of stages before they are received by the output bus.

3. The processing system of claim 2, wherein the at least one stage of the plurality of stages comprises at least two filters connected to the event bus of that stage.

4. The processing system of claim 1, wherein each of the plurality of stages comprises more than one processing element, the event bus in each subsequent stage being connected to the more than one processing element of the previous stage such that the event bus is configured to receive the output events generated by the more than one processing elements.

5. The processing system of claim 1, wherein, in at least one stage of the plurality of stages, at least one of the one or more processing elements is connected recurrently to the event bus of that stage such that the event bus of that stage is configured to receive the output event generated by the at least one of the one or more processing elements.

6. The processing system of claim 5, wherein, in the at least one stage, a plurality of the one or more processing elements is connected recurrently to the event bus of that stage.

7. The processing system of claim 1, wherein each event is represented by a source address, data payload, and a temporal index.

8. The processing system of claim 7, wherein the temporal index represents a phase of the event.

9. The processing system of claim 1, wherein each processing element comprises an address generator configured to determine target addresses for the received event, the target addresses identifying a synaptic state and a synaptic weight corresponding to the received event, and wherein the synaptic input stage comprises accumulation of weights for the received event based on the identified synaptic state and synaptic weight, and the neural output stage comprises accumulation of inputs from the synaptic input stage and generation of the output event using a neural nonlinearity processor.

10. The processing system of claim 9, further comprising a phase controller configured to track the phase of received events and to trigger operation of the synaptic input stage and/or neural output stage.

11. The processing system of claim 10, wherein the phase controller tracks the phase of received events using at least one bit in a data representation of the received events.

12. The processing system of claim 9, wherein the address generator generates addresses using a loop iteration for use in implementing 2D convolution by the processing element.

13. The processing system of claim 9, wherein synapses in the synaptic input stage are assigned to neurons in the neuron output stage by a neuron-to-synapse map.

14. The processing system of claim 9, wherein the neural nonlinearity processor is configured to rectify the accumulated inputs received by the neural nonlinearity processor, emit an integer portion of a current neural state based on the accumulated inputs, and set the current neural state to a fractional portion of the accumulated inputs.

15. A digital hardware system for processing neural networks over time, the system comprising a plurality of hardware elements, each element comprising:
an address generator configured to determine target addresses for a received event, the target addresses identifying a synaptic state and a synaptic weight corresponding to the received event;
a synaptic accumulator configured to accumulate weights for the received event based on the identified synaptic state and synaptic weight;
a neural accumulator configured to accumulate inputs from the synaptic accumulator; and
a neural nonlinearity processor configured to generate an output event from accumulated inputs from the neural accumulator.
and generation of the output event using a neural nonlinearity processor.

16. The system of claim 15, further comprising a phase controller configured to track the phase of the received event and trigger operation of the neural accumulator.
